(19) United States
(12) Patent Application Publication
(10) Pub. No.: US 2017/0270777 A1
(43) Pub. Date: Sep. 21, 2017

(54) HUMANITARIAN CAMP SHELTER COMMUNICATION SYSTEM

(71) Applicant: Gichner Systems Group, Inc., Dallastown, PA (US)

(72) Inventors: Jack Mizrahi, Dollard Des Ormeaux (CA); Scott David Sarine, Red Lion, PA (US); Brian Andrew McIlvaine, Red Lion, PA (US)

(73) Assignee: Gichner Systems Group, Inc., Dallastown, PA (US)

(21) Appl. No.: 15/074,891

(22) Filed: Mar. 18, 2016

(51) Int. Cl. G08B 25/12; H04W 4/00; G06K 7/10; H04W 4/22; E04H 9/16; G08B 25/10

(52) U.S. Cl. CPC G08B 25/12; E04H 9/16; G08B 25/10; G06K 7/10366; H04W 4/22; H04W 4/008; H04W 84/18

(57) ABSTRACT

A humanitarian camp shelter communication system for a humanitarian camp is disclosed herein. In embodiments, the humanitarian shelter communication system includes a plurality of shelter nodes, a plurality of individual identifiers, a plurality of tag readers, and a communication controller. Each individual identifier has an identifier tag for identifying each of the individual identifiers to the humanitarian camp shelter communication system. The plurality of tag readers detects the identifier tags. An individual identifier and a shelter node are associated with a displaced person staying at the humanitarian camp. The communication controller can send messages to the plurality of shelter nodes and has a locator operable to determine the location of the individual identifier based on which of the plurality of tag readers detected the identifier tag.

### TECHNICAL FIELD

The present disclosure generally pertains to communication systems, and is directed toward a humanitarian camp shelter communication system.

### BACKGROUND

Natural disasters, wars, and other international conflicts can potentially displace millions of people from their homes. Providing for the needs of those displaced, such as safe shelter and medical aid, can be challenging and expensive.

### SUMMARY OF THE DISCLOSURE

A humanitarian camp shelter communication system for a humanitarian camp is disclosed herein. In embodiments, he humanitarian shelter communication system includes a plurality of shelter nodes, a plurality of individual identifiers, a plurality of tag readers, an administrative computer system, a communication controller, and a plurality of routers. Each shelter node includes a display, a receiver, and a shelter power source for providing electrical power to the shelter node. The shelter power source includes a solar panel and a battery connected to the solar panel. Each individual identifier has an identifying character string and an identifier tag. The identifier tag stores the identifying character string for identifying each of the individual identifiers to the humanitarian camp shelter communication system. The plurality of tag readers detect the identifier tag and obtain the identifying character string from the identifier tag of each of the individual identifiers.

The administrative computer system has an administrative controller operable to receive displaced person data and associate a displaced person with a shelter node of the plurality of shelter nodes and with an individual identifier of the plurality of individual identifiers. The communication controller provides communication for the administrative computer system with the plurality of shelter nodes. The communication controller has a locator operable to determine the location of the individual identifier based on which of the plurality of tag readers detected the identifier tag. The plurality of routers communicates with the communication controller and with the plurality of shelter nodes.

A method for managing a humanitarian camp with a humanitarian camp shelter communication system is also disclosed herein. In embodiments, the method includes the administrative computer system associating a displaced person with an individual identifier of the plurality of individual identifiers by linking a character string that identifies the displaced person with an identifying character string of the individual identifier obtained by one of the plurality of tag readers from an identifier tag of the individual identifier. The method also includes the communication controller locating the displaced person by determining which of the plurality of tag readers detected the identifier tag.

The method further includes the administrative computer system associating the displaced person with a shelter node of the plurality of shelter nodes by searching a database for the plurality of shelter nodes for an available shelter node and linking the character string that identifies the displaced person with a second character string that identifies the available shelter node. The method yet further includes the communication controller sending a message to the displaced person by receiving the message from the administrative computer system, searching the database for the second character string and sending the message the shelter node assigned to the second character string, and the shelter node displaying the message on a display.

### BRIEF DESCRIPTION OF THE DRAWINGS

FIG. 1 is a schematic illustration of an embodiment of a humanitarian camp shelter communication system.

FIG. 2 is a schematic illustration of an alternate embodiment of the humanitarian camp shelter communication system.

FIG. 3 is a functional block diagram of the communication controller of FIGS. 1 and 2.

FIG. 4 is a functional block diagram of the administrative computer system of FIGS. 1 and 2.

FIG. 5 is a functional block diagram of a router of FIGS. 1 and 2.

FIG. 6 is a functional block diagram of a shelter node of FIGS. 1 and 2.

FIG. 7 is a functional block diagram of an embodiment of an individual identifier of FIGS. 1 and 2.

FIG. 8 is a functional block diagram of an alternate embodiment of an individual identifier of FIGS. 1 and 2.

FIG. 9 is a flowchart of a method of supplying humanitarian aid with the humanitarian camp shelter communication system of FIGS. 1 and 2.

### DETAILED DESCRIPTION

The systems and methods disclosed herein include a humanitarian camp shelter communication system for use in a humanitarian camp for providing humanitarian aid to displaced persons, such as refugees, from their homes. In embodiments, the humanitarian camp shelter communication system includes shelter nodes located in networked shelters interlinked with an administrative computer system. Interlinking the shelter nodes with the administrative computer system may allow administrators of the camp to communicate information to each networked shelter and may allow a displaced person to request help in an emergency.

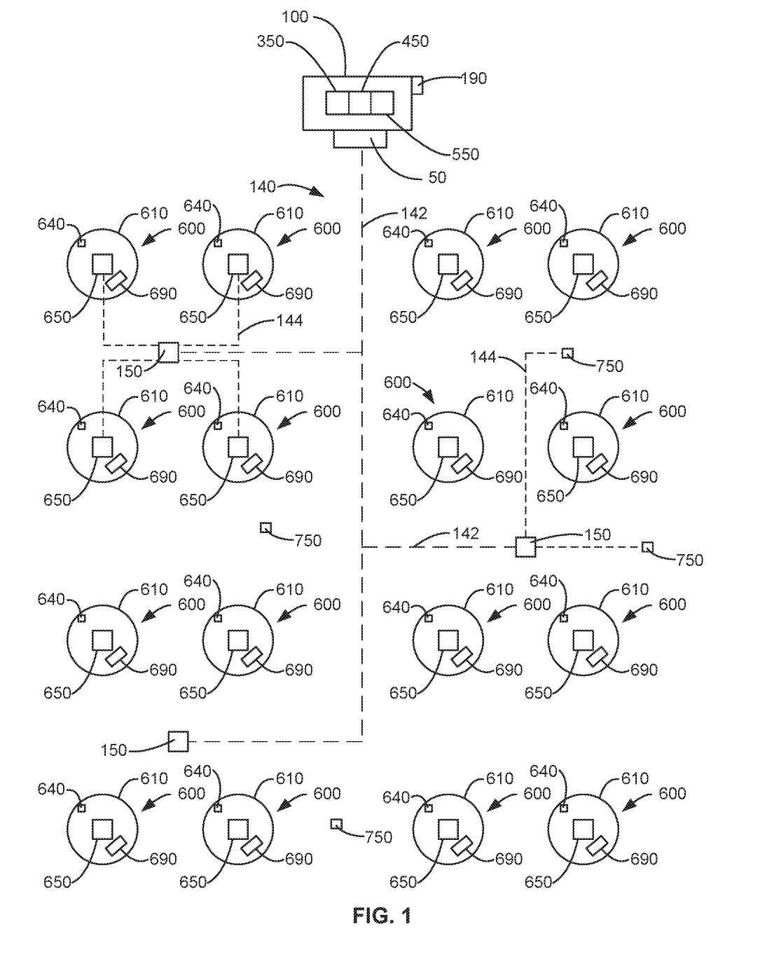

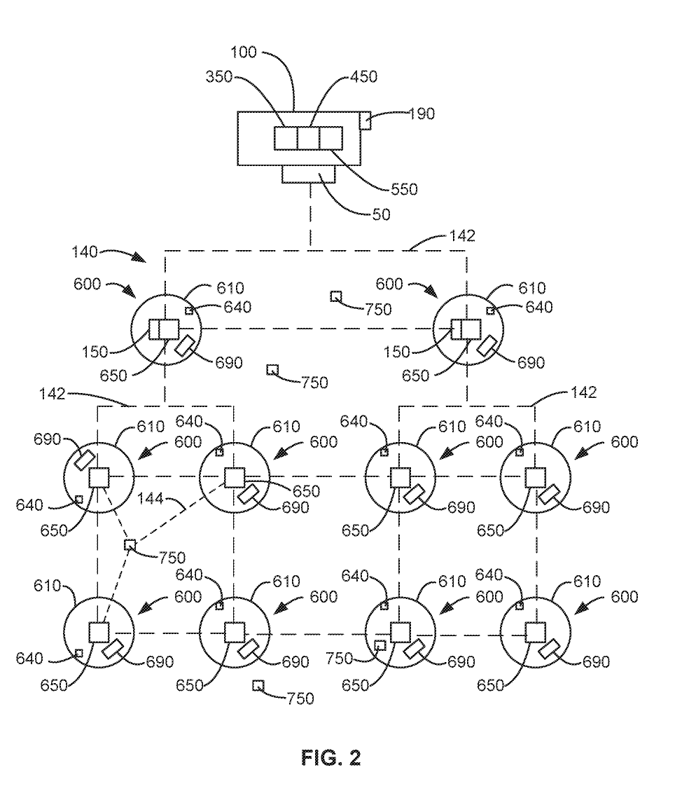

FIG. 1 is a schematic illustration of a humanitarian camp shelter communication system. FIG. 2 is a schematic illustration of an alternate embodiment of the humanitarian camp shelter communication system. Referring to FIGS. 1 and 2, the humanitarian camp shelter communication system may include an administrative computer system 100, a communication controller 50, routers 150, shelter nodes 650, and individual identifiers 750, such as, for example, humanitarian bands (H-bands), interlinked via a communication network generally indicated as 140. The administrative computer system 100 may include an administrative controller 350, a security controller 450, a medical controller 550 and an administrative power source 190. The administrative controller 350, the security controller 450, and the medical controller 550 can be a single unit, separate units, or can be a combination of units. In the embodiments, each is a separate unit with the administrative controller 350 located in an administration post, the security controller 450 located in a security post, and the medical controller 550 located in a medical post.

The administrative computer system 100 and associated posts may be housed in one or more administrative shelters. The administrative shelter(s) may be temporary, semi-permanent, or permanent structures. The administrative shelters may be hard shelters, such army standard family (ASF) shelters and expandable ASF shelters.

The administrative power source 190 may provide power to the administrative computer system 100, lighting, and other instrumentation. The administrative power source 190 may be a generator, solar panels, batteries, or a combination thereof.

Each shelter node 650 may be located in a humanitarian shelter 610 and may be secured to the humanitarian shelter 610. The humanitarian shelter 610 may be a temporary, a semi-permanent, or a permanent shelter. Any shelter capable of housing one or more displaced persons may be used. The humanitarian shelter 610 combined with a shelter node 650 may be considered a networked shelter 600. In embodiments, all or portions of the shelter node 650 may be secured to the humanitarian shelter in a location that is out of reach of the displaced persons to prevent theft of the components within the shelter node 650.

Each shelter node 650 may include a shelter power source 690 and a shelter security device 640. The shelter power source 690 may provide power to the shelter node 650, to lighting, and other instrumentation in or around the humanitarian shelter 610. The shelter power source 690 may include solar cells, such as one or more solar panels, one or more batteries, a hand crank power generator, a pedal power generator, or a combination thereof. The solar panels may be located on the roof of the humanitarian shelter 610, while the batteries may be located within the Shelter node 650 or secured to the humanitarian shelter 610, such as to the frame of the humanitarian shelter 610 outside the reach of the displaced persons. The shelter security device 640 may include a light and a motion sensor that activates the light when motion is detected within a predetermined range.

The communication controller 50 may act as the network coordinator and control the information sent between the administrative computer system 100 and the other nodes in the system, such as the shelter node 650 and the individual identifier 750. The router(s) 150 may be operable to serve as an intermediary between the communication controller 50 and the other nodes. The signal sent between the communication controller 50 and the router(s) 150 may be sent over a higher powered signal, while the signal sent between the router(s) 150 and the other nodes may be sent over a lower powered signal, such as over a ZigBee network. The higher powered signal may consume more energy and may have a greater range than the lower powered signal.

The communication controller 50, the router(s) 150, the Shelter nodes 650, and the individual identifiers 750 include wireless communication hardware so that the communication controller 50 can communicate with each Shelter node 650 and each individual identifier 750. The communication network 140 configuration may be a mesh configuration, a star configuration, a cluster tree configuration, or a combination thereof. The communication network 140 may be subdivided into a backhaul network 142 and one or more local networks 144. The long dashed lines between network nodes represent communication paths or links between nodes of the backhaul network 142, while the short dashed lines between network nodes represent communication paths or links between nodes of the local network(s) 144. Only portions of the local network(s) communication links are shown for clarity.

In the embodiment illustrated in FIG. 1, the backhaul network 142 includes a wireless links between the communication controller 50 and the router(s) 150. The wireless link between the communication controller 50 and the router(s) 150 may be made over a high powered signal and may have an operable range longer than that of the other links in the communication network 140. This may allow the router(s) 150 to be located further from the communication controller 50. In the embodiment illustrated in FIG. 1, the local network(s) 144 include wireless links between the router(s) 150 and the shelter nodes 650, and between the router(s) 150 and the individual identifiers 750. The local network links may be made over a low powered signal and may have an operable range that is shorter than the wireless signal that is used to connect the communication controller 50 and the router(s) 150. In some embodiments, such as the embodiment illustrated in FIG. 1, there may only be one way communication between the router(s) 150. In these embodiments, the shelter nodes 650 may only include a transmitter, which may minimize the power consumption of the shelter nodes 650.

In other embodiments, such as the embodiment illustrated in FIG. 2, the backhaul network includes a wireless link between the communication controller 50 and the router(s) 150 over a high powered network, and a mesh network formed by the shelter nodes 650 communicating with adjacent shelter nodes 650 over a low power network, such as a ZigBee network. The router(s) 150 may be linked to one or more shelter nodes 650. In the embodiment illustrated in FIG. 2, each router 150 is located adjacent to or within the shelter node 650. Each router 150 may be connected to the adjacent shelter node 650 over a wired link. The communication controller 50 may control and coordinate the communication paths between the communication controller 50 and each shelter node 650 over the mesh network.

In the embodiment illustrated in FIG. 2, the local network(s) 144 include communication links between the shelter nodes 650 and the individual identifiers 750. The local network(s) 144 may be used to triangulate the position of each individual identifier 750 and may be used to send information to the individual identifier 750. The shelter nodes 650 are static nodes and can be used to triangulate the position of an individual identifier 750, such as by determining the position of the individual identifier 750 relative to three Shelter nodes 650. Each individual identifier 750 may be assigned to a displaced person within the camp. The communication network 140 can be used to communicate information to the displaced person and to determine whether the displaced person is at the camp and where the displaced person is within the camp.

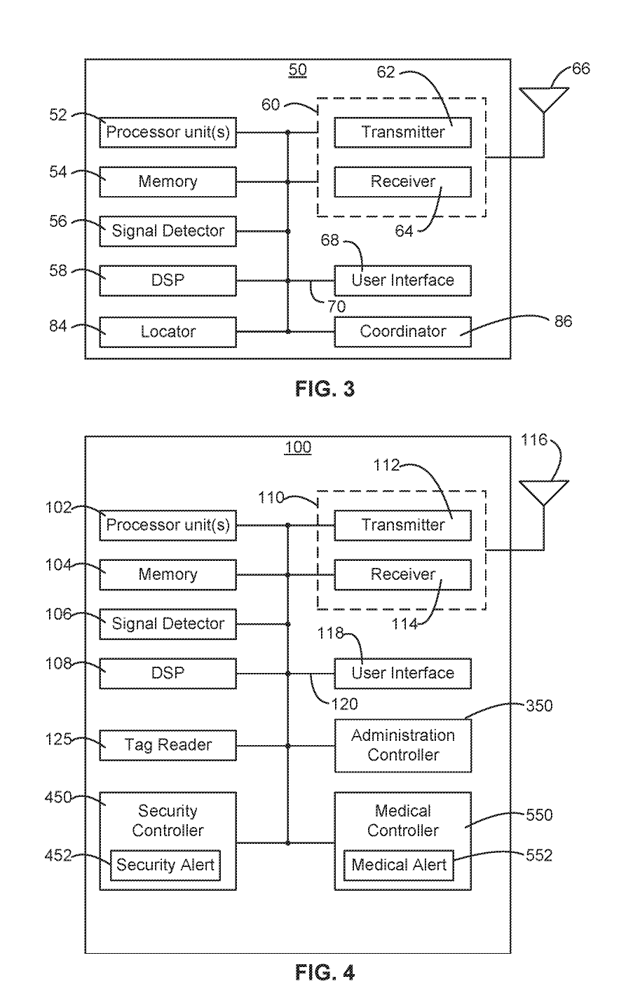

FIG. 3 is a functional block diagram of the communication controller 50 of FIGS. 1 and 2. The communication controller 50 is an embodiment of a device that can be configured and can be operable to implement all or portions of the various methods described herein. The communication controller 50 can include one or more processors or processor units 52. The processor 52 can controls operation of the communication controller 50. The processor 52 can also be referred to as a central processing unit (CPU). The communication controller 50 can also have a memory 54 coupled to the processor 52. The memory 54 can include both read-only memory (ROM) and random access memory (RAM). The memory 54 can provide instructions and data to the processor 52. At least a portion of the memory 54 can also include non-volatile random access memory (NVRAM). The processor 52 can performs logical and arithmetic operations based on program instructions stored within the memory 54. The instructions in the memory 54 can be executable to implement the methods described herein. In some embodiments, the memory 54 can be implemented to store, for example, the locations of individual identifiers 750. In some embodiments, the memory 54 can be implemented to store, for example, the character string assigned to each shelter node 650 and the location of each shelter node 650.

The processor 52 can include or be a component of a processing system implemented with one or more processors 52. The one or more processors can be implemented with any combination of general-purpose microprocessors, microcontrollers, digital signal processors (DSPs), field programmable gate array (FPGAs), programmable logic devices (PLDs), controllers, state machines, gated logic, discrete hardware components, dedicated hardware finite state machines, or any other suitable entities that can perform calculations or other manipulations of information.

The processing system and the memory 54 can also include machine-readable media for storing software. Software shall be construed broadly to mean any type of instructions, whether referred to as software, firmware, middleware, microcode, hardware description language, or otherwise. Instructions can include code (e.g., in source code format, binary code format, executable code format, or any other suitable format of code). The instructions, when executed by the one or more processors, cause the processing system to perform the various functions described herein.

The communication controller 50 can also include a transmitter 62 and/or a receiver 64 to allow transmission and reception of data between the communication controller 50 and the router(s) 150 and/or shelter nodes 650. The transmitter 62 and/or receiver 64 can also allow transmission and reception of data between the communication controller 50 and a remote location. The transmitter 62 and the receiver 64 can be combined into a transceiver 60. The communication controller 50 can also have one or more antennas 66 electrically coupled to the transceiver 60. The communication controller 50 can also include (not shown) multiple transmitters, multiple receivers, multiple transceivers, and/or multiple antennas as needed for various communication standards.

The transmitter 62 can be configured to wirelessly transmit packets having different packet types or functions. For example, the transmitter 62 can be configured to transmit packets of different types generated by the processor 52. The receiver 64 can be configured to wirelessly receive packets having different packet types. In some examples, the receiver 64 can be configured to detect a type of a packet used and to process the packet accordingly.

In some embodiments, the transmitter 62 and the receiver 64 can be configured to transmit and receive information via other wired or wireline systems or means.

The communication controller 50 can also include a signal detector 56 that can be used in an effort to detect and quantify the level of signals received by the transceiver 60. The communication controller 50 can also include a digital signal processor (DSP) 58 for use in processing signals. The DSP 58 can be configured to generate a packet for transmission.

The communication controller 50 can further include a user interface 68. The user interface 68 can include a keypad, a microphone, a speaker, and/or a display. The user interface 68 can include any element or component that conveys information to a user of the communication controller 50 and/or receives input from the user.

The various components of the communication controller 50 can be coupled together by a bus system 70. The bus system 70 can include a data bus, for example, as well as a power bus, a control signal bus, and a status signal bus in addition to the data bus. The components of the communication controller 50 can be coupled together or accept or provide inputs to each other using some other mechanism.

The communication controller 50 may also include a coordinator 86 and a locator 84. The coordinator 86 may act as a root and bridge between the administrative computer system 100 and the communication network 140. The coordinator 86 may handle and store information received from the shelter nodes 650 and the individual identifiers 750. The coordinator 86 may route information received from the administrative computer system 100 to one or more specified shelter nodes 650 and individual identifiers 750. Similarly, the coordinator 86 may route information received from a shelter node 650 or an individual identifier 750 to the administrative computer system 100.

The locator 84 may determine the location of each individual identifier 750 and store the location of each individual identifier 750. The locator 84 may determine the location of each individual identifier 750 by triangulating the location of the individual identifier 750 using the known locations of 3 or more nodes, such as shelter nodes 650, routers 150, or other individual identifiers 750 and determining the distance of the individual identifier 750 from each node. Once the distances to each node are determined, the location of the individual identifier 750 can be determined based on those distances and the relative distances between the nodes. The locator 84 may also determine whether or not the individual identifier 750 is located within the networked shelter 600 assigned to the displaced person associated with the individual identifier 750. The locator 84 may provide this determination to the shelter node 650 associated with the networked shelter 600 and to the individual identifier 750 associated with the parent or guardian of the displaced person.

Although a number of separate components are illustrated in FIG. 3, one or more of the components can be combined or commonly implemented. For example, the processor 52 can be used to implement not only the functionality described above with respect to the processor 52, but also to implement the functionality described above with respect to the coordinator 86 and the locator 84. In some embodiments, each of the components illustrated in FIG. 3 can be implemented using a plurality of separate elements. Each separate element can include a processor 52, a memory 54, a signal detector 56, a DSP 58, a transceiver 60, a user interface 68 and a bus system 70.

FIG. 4 is a functional block diagram of the administrative computer system 100 of FIGS. 1 and 2. The administrative computer system 100 is an embodiment of a device that can be configured and can be operable to implement all or portions of the various methods described herein. The administrative computer system 100 may include one or more processors or processor units 102, memory 104, a transmitter 112, a receiver 114, a signal detector 106, a DSP 108, a bus system 120, and a user interface 118. The processor(s) 102, memory 104, transmitter 112, receiver 114, signal detector 106, DSP 108, bus system 120, and user interface 118 of the administrative computer system 100 may be the same or similar to the processor(s) 52, memory 54, transmitter 62, receiver 64, signal detector 56, DSP 58, bus system 70, and user interface 68 for the communication controller 50 described above.

The administrative computer system 100 may include an administrative controller 350, a security controller 450, and a medical controller 550. The administrative controller 350 may receive displaced person information, such as name, age, family members, and medical information. The administrative controller 350 may also assign a networked shelter 600 to one or more displaced persons and may assign an individual identifier 750 to a displaced person.

The security controller 450 may include a security alert 452. The security alert 452 is configured to receive a security request signal from a shelter node 650 and alert security personnel of the request. The security alert 452 may alert security personnel by providing identifying information of the shelter node 650, such as the location and identification number of the networked shelter 600. This information may be provided through the user interface 168, such as by displaying the information in the user interface 168 or by forwarding the information to a device carried by the security personnel.

The medical controller 550 may receive, display, and store medical information of displaced persons. The medical controller 550 may be configured to comply with regulations of the host country related to the personal health information of the displaced persons. The medical controller 550 may include a medical alert 552. The medical alert 552 is configured to receive a medical aid request signal from a shelter node 650 and alert medical personnel of the request. The medical alert 552 may alert medical personnel by providing identifying information of the shelter node 650, such as through the user interface 168 or by forwarding the information to a device carried by the medical personnel. In some embodiments, the medical alert 552 and the security alert 452 are implemented in a single module as an emergency alert, which may issue a general emergency alert rather than a specific medical or security alert.

The administrative computer system 100 may also include a tag reader 125. The tag reader 125 is configured to read an identifier tag 772 (discussed below) and provide the information read, such as an identifier tag identification character string, to one or more of the controllers including the administrative controller 350, the security controller 450, or the medical controller 550. The controller that receives the information may display information related to the displaced person associated with the individual identifier 750. The tag reader 125 may also be used when associating a displaced person with the tag reader 125 or when administering aid, such as medical care, medications, equipment, or food, to the displaced person. Using the tag reader 125 while administering aid may be used to track the aid provided to the displaced person. The tag reader 125 may include, inter alia, a radio frequency identification (RFID) reader or an optical scanner for reading an optical representation of data, such as a barcode.

Although a number of separate components are illustrated in FIG. 4, one or more of the components can be combined or commonly implemented. For example, the processor 102 can be used to implement not only the functionality described above with respect to the processor 102, but also to implement the functionality described above with respect to the administrative controller 350, the security controller 450, the medical controller 550, and the tag reader 125. In some embodiments, each of the components illustrated in FIG. 4 can be implemented using a plurality of separate elements. Each separate element can include a processor 102, a memory 104, a signal detector 106, a DSP 108, a transceiver 110, a user interface 118 and a bus system 120. For example, the administrative controller 350, the security controller 450, and the medical controller 550 can be separate elements located in separate administrative shelters.

In some embodiments, the communication controller 50 may be combined or partially combined with the administrative computer system 100. For example, the communication controller 50 may be accessed using the user interface 118 of the administrative computer system 100.

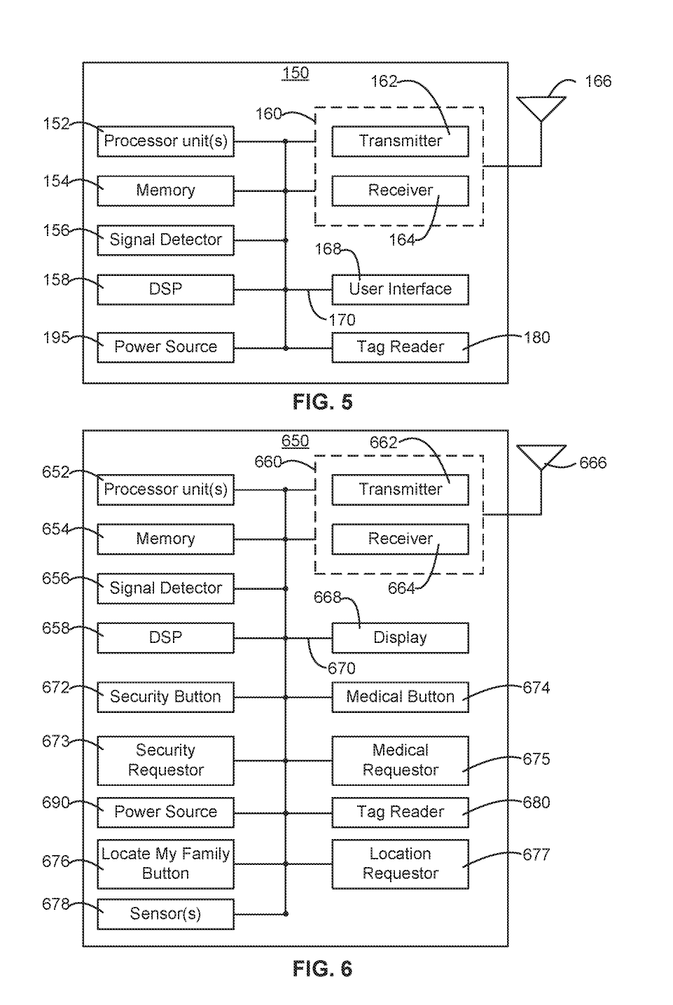

FIG. 5 is a functional block diagram of a router 150 of FIGS. 1 and 2. The router 150 is an embodiment of a device that can be configured and can be operable to implement all or portions of the various methods described herein. The router 150 may include one or more processors or processor units 152, memory 154, a transmitter 162, a receiver 164, a signal detector 156, a DSP 158, a bus system 170, and a user interface 168. The processor(s) 152, memory 154, transmitter 162, receiver 164, signal detector 156, DSP 158, bus system 170, and user interface 168 of the router 150 may be the same or similar to the processor(s) 52, memory 54, transmitter 62, receiver 64, signal detector 56, DSP 58, bus system 70, and user interface 68 for the communication controller 50 described above. In some embodiments, the router(s) 150 may be accessed remotely via the administrative computer system 100 and the communication controller 50.

In some embodiments, such as the embodiment illustrated in FIGS. 1 and 2, the one or more transceivers 160 and antennas 166 are configured to transmit and receive high power and low power signals. In some embodiments, such as the embodiment illustrated in FIG. 1, the router(s) 150 also include a tag reader 180, such as an RFID reader. The tag readers 180 of the router(s) 150 may transmit and receive signals to and from the identifier tags 772 (discussed below), which may be used to determine the location of the identifier tags 772, such as by determining the distance between the router 150 and the individual identifier 750 based on the strength of the signal received from the identifier tag 772.

Although a number of separate components are illustrated in FIG. 5, one or more of the components can be combined or commonly implemented. For example, the processor 102 and the transceiver 160 can be used to implement not only their functionalities described above, but also to implement the functionality described above with respect to the tag reader 180.

FIG. 6 is a functional block diagram of a shelter node 650 of FIG. 1. The shelter node 650 is an embodiment of a device that can be configured and can be operable to implement all or portions of the various methods described herein. The Shelter node 650 may include one or more processors or processor units 652, memory 654, a transmitter 662, a receiver 664, a signal detector 656, a DSP 658, a bus system 670, and a display 668. The processor(s) 652, memory 654, transmitter 662, receiver 664, signal detector 656, DSP 658, and bus system 670 of the Shelter node 650 may be the same or similar to the processor(s) 52, memory 54, transmitter 62, receiver 64, signal detector 56, DSP 58, and bus system 70 described above for the communication controller 50 described above. The display 668 may be a low power display, such as an electronic ink (E ink) display. In some embodiments, the display 668 is a touch screen E ink display.

The Shelter node 650 may also include a security button 672, a security requestor 673, a medical button 674, a medical requestor 675, a locate my family button 676, and a location requestor 677. The security button 672 and the medical button 674 may be located on an external surface of the Shelter node 650. The security requestor 673 may be configured to send a request for help to the security controller 450 when the security button 672 is activated. In some embodiments, the security requestor 673 may display the family members and may display the persons associated with the individual identifiers 750 that the shelter node 650 is currently reporting to the locator 84. The user may be prompted to select which family member or person is in need of security assistance.

The medical requestor 675 may be configured to send a request for medical assistance to the medical controller 550 when the medical button 674 is activated. The request for help sent from the security requestor 673 and the medical requestor 675 may include information to identify the Shelter node 650 and its locations, such as character strings assigned to the shelter node and the networked shelter. In some embodiments, the medical requestor 675 may display the family members and may display the persons associated with the individual identifiers 750 that the shelter node 650 is currently reporting to the locator 84. The user may be prompted to select which family member or person is in need of medical assistance.

The medical button 674 and the security button 672 may be implemented on a button, switch, lever, sensors, or other types of hardware capable of sending a signal or interrupting a signal to denote its use. In some embodiments, the medical button 674 and the security button 672 may be implemented using a single piece of hardware. In other embodiments, only a single button, such as the security button 672, is used as an emergency button to denote the need for emergency assistance, such as medical or security assistance. In such embodiments, the shelter node 650 the security requestor 673 may be implemented as an emergency requestor which may send a general emergency request to the administrative computer system 100.

The locate my family button 676 may also be located on an external surface of the Shelter node 650 and may be implemented on a button, switch, lever, sensors, or other types of hardware capable of sending a signal or interrupting a signal to denote its use. The location requestor 677 may be configured to send a request for the location of one or more family members to the locator 84. The locator 84 may determine the location(s) of the one or more family members and return their locations to the shelter node 650, which may show their locations on the display 668. In some embodiments, the location requestor 677 may display the family members on display 668 and may allow the user to select which family member(s) to locate.

In embodiments where a touch screen is used, each button may be illustrated as an icon on display 668 rather than as a separate hardware button. In embodiments, the shelter node 650 may be configured to send personalized messages to the administrative computer system 100, other shelter nodes 650, and to individual identifiers 750.

In further embodiments, the shelter node 650 may include other inputs, such as up and down buttons for selecting objects shown on display 668 or for scrolling through the messages sent to the shelter node 650. Some embodiments also include one or more sensors 678, such as temperature sensors and carbon dioxide detection sensors.

In some embodiments, the shelter node 650 can be implemented using a plurality of separate elements. For example, the display 668, security button 672, and the medical button 674 may be located within reach of the displaced persons, such as mounted on a wall or the frame of the humanitarian shelter 610, while the remainder of the elements of shelter node 650 may be located out of the reach of the displaced persons, such as near the top of the humanitarian shelter 610 or on the roof of the humanitarian shelter 610. In some embodiments, the shelter node 650 may include a modular hardware design so that the various elements of the shelter node 650 may be quickly and easily added or removed depending on the needs of a humanitarian camp.

Some of the elements of the shelter node 650, such as the display 668, security button 672, and medical button 674, may be secured to the humanitarian shelter 610 in a location accessible to the displaced person, while other elements, such as the processor 652, memory 654, transceiver 660, and tag reader 680, may be secured out of the reach of the displaced person.

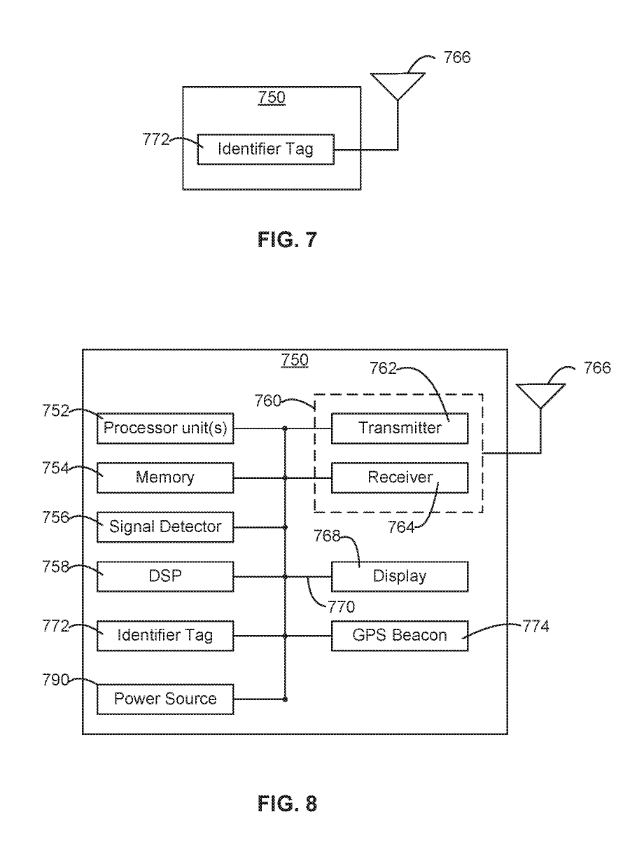

FIG. 7 is a functional block diagram of an embodiment of an individual identifier 750 of FIGS. 1 and 2. The individual identifier 750 is an embodiment of a device that can be configured and can be operable to implement all or portions of the various methods described herein. The individual identifier 750 may include one or more identifier tags 772. The identifier tags 772 may be, inter alia, an RFID tag or an optical machine readable representation of data, such as a linear barcode or a matrix barcode. The data stored or represented by the identifier tags(s) 772 may include an identifying character string, such as a serial number of the individual identifier 750. In some embodiments, both an RFID tag and an optical machine readable representation of data are used. Tag reader(s) 180, 680 including an RFID reader can be used to identify and locate the identifier tag 772 that includes an RFID tag, while a tag reader 125 that includes an optical machine can be used to scan the identifier tag 772 that includes an optical machine readable representation of data to identify the identifier tag 772.

FIG. 8 is a functional block diagram of an alternate embodiment of an individual identifier 750 of FIGS. 1 and 2. In the embodiment illustrated in FIG. 8, the individual identifier 750 includes one or more processors or processor units 752, memory 754, a transmitter 762, a receiver 764, a signal detector 756, a DSP 758, a bus system 770, and a display 768. The processor(s) 752, memory 754, transmitter 762, receiver 764, signal detector 756, DSP 758, and bus system 770 of the individual identifier 750 may be the same or similar to the processor(s) 52, memory 54, transmitter 62, receiver 64, signal detector 56, DSP 58, and bus system 70 described above for the communication controller 50 described above. The display 768 may be a low power display, such as an E ink display. In some embodiments, the display 768 may be a touch screen E ink display.

The individual identifier 750 may also include one or more identifier tags 772, a GPS beacon 774, and an individual identifier power source 790. The GPS beacon 774 may be configured to transmit on a predetermined schedule to limit the power consumption of the GPS beacon. Further, the GPS beacon may be configured to log its position one or more times between transmissions. The individual identifier power source 790 may include, inter alia, solar cells, batteries, or a combination thereof.

While the embodiments of the individual identifiers 750 of FIGS. 7 and 8 are described herein. Other embodiments of the individual identifiers 750 are contemplated using any combination of the elements of the embodiments of FIGS. 7 and 8, and any of the elements of the shelter node 650, such as the security button 672, medical button 674, and the locate my family button 676. For example, one embodiment of the individual identifier 750 includes an identifier tag 772, a GPS beacon 774, and a power source 790, but not any of the other elements.

The humanitarian camp shelter communication system may maintain one or more databases to maintain a record of which individual identifier 750 is associated with a displaced person and which networked shelter 600 the displaced person is assigned to. The database(s) may include character strings that identify the displaced person, the individual identifier 750, the networked shelter 600 and the shelter node 650, such as a record number assigned to the displaced person's data, a serial number of the individual identifier 750, or an identification number of the shelter node 650. The database(s) may be stored in the memory 54 of the communication controller 50, the memory 104 of the administrative computer system 100, or on an associated server.

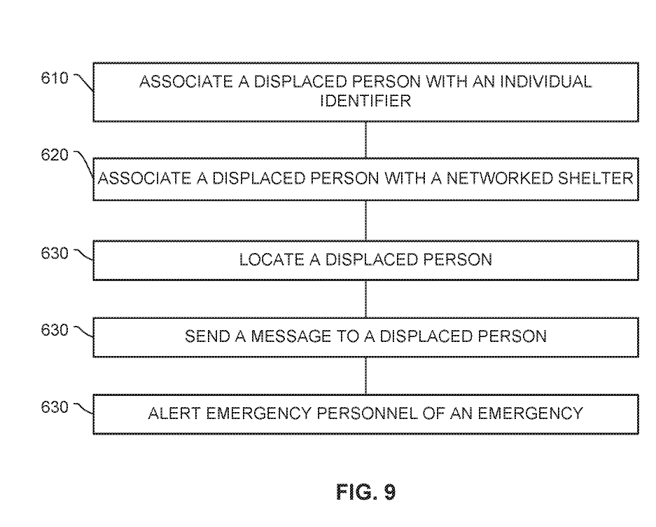

FIG. 9 is a flowchart of a method for managing a humanitarian camp with the humanitarian camp shelter communication system of FIGS. 1 and 2. The method may include associating a displaced person with an individual identifier 750 at step 810. Associating a displaced person with an individual identifier 750 may include the administrative computer system 100 receiving displaced person data, such as the name, age, citizenship, medical information and familial relationships, receiving an identifying character string of the individual identifier 750, such as a serial number, of the individual identifier 750, and linking the identifying character string to the displaced person data. In some embodiments, the identifying character string is included in the displaced person data. In some embodiments, a database of the identifying character strings of the individual identifiers 750 is maintained where a character string identifying the displaced person, such as a record number assigned to the displaced person data or the displaced person's name, is stored and linked to the identifying character string.

The displaced person data may be received from inputs in the user interface, from a source external to the camp over the internet, or from the memory of a removable storage device, such as a removable hard drive or USB flash drive. The identifying character string is received from the individual identifier by the tag reader 125, such as via RFID or an optical machine readable representation of data.

The method may also include associating a displaced person with a networked shelter 600 at step 820. Associating a displaced person with a networked shelter 600 may include the administrative computer system 100 searching a database of the networked shelters 600 or shelter nodes 650 for an available networked shelter 600 and linking the displaced person to that networked shelter 600 or to the shelter node 650, such as by storing a character string identifying the displaced person, such as a record number assigned to the displaced person data and linking the character string to a character string that identifies the networked shelter 600, such as a character string associated with the shelter node 650, in the database.

The method may further include locating a displaced person at step 830. Locating a displaced person may include the communication controller obtaining the identifying character string for the individual identifier 750 associated with the displaced person. The identifying character string may be obtained by searching the database of individual identifiers 750 or by receiving the identifying character string from the administrative computer system 100. Locating a displaced person may also include the communication controller determining which nodes that include a tag reader, such as router(s) 150 and networked shelter(s) 600, have detected the identifier tag 772 of the individual identifier 750 and determining how far the individual identifier 750 is from each of those nodes.

Locating the displaced person may also include pinpointing the location of the individual identifier 750 based on the location of the nodes and the distance between each of those nodes and the individual identifier 750. The communication controller 50 may then provide the determined location to the administrative computer system 100 or to a shelter node 650. The accuracy of locating a displaced person may depend on how many nodes detect the identifier tag 772. The communication controller 50 may also provide an accuracy of the displaced person's location based on the number of nodes that detected the identifier tag 772 and the location of those nodes.

In some embodiments, locating the displaced person also includes determining whether the displaced person is located within the humanitarian shelter 610 or near the shelter node 650 assigned to the displaced person by comparing the location of the shelter node 650 to the location of the displaced person. If the displaced person's location is within a predetermined distance to the shelter node 650 then the displaced person is considered to be within the networked shelter 600 or near the shelter node 650. The predetermined distance may depend on the size of the networked shelter 600. Locating the displaced person may also include providing the determination of whether the displaced person is located within the networked shelter 600 to the shelter node 650 of the assigned networked shelter 600. Locating the displaced person may further include showing where in the camp the displaced person is located on the display 668 of the shelter node 650 associated with the displaced person.

The method may still further include sending a message to a displaced person at step 840. Sending a message to a displaced person may include the communication controller 50 receiving a message from the administrative computer system 100 and the communication controller 50 sending the message to the shelter node 650 assigned to the displaced person. In some embodiments, the individual identifier 750 also includes a display 768. In those embodiments, step 840 may also include the communication controller 50 sending the message to the individual identifier 750 associated with the displaced person. In some embodiments, step 840 may also include sending the message to the shelter node 650 where the displaced person currently resides or to the shelter node 650 currently reporting the identifier tag 772 of the individual identifier 750 of the displaced person to the locator 84. Step 840 may include the communication controller obtaining the identifying character string for the individual identifier 750 associated with the displaced person and the character string that identifies the associated networked shelter 600, such as by searching the database(s) for the networked shelters and the individual identifiers.

The method may also include alerting emergency personnel of an emergency at step 850. Step 850 may include the administrative computer system 100 receiving an emergency request from a shelter node 650. The emergency request may signify that there is a general emergency, a medical emergency, or a security emergency. The emergency request may include the type of emergency and the location of the networked shelter 600 depending on which emergency button was selected at the shelter node 650. Step 850 may also include alerting emergency personnel to the request, such as by displaying the emergency request at the security controller 450, displaying the emergency request at the medical controller 550, sounding an alarm, or sending the emergency request to a device carried by the emergency personnel.

In embodiments, the method may further include the locator 84 reporting a lost person. The locator 84 may record a time stamp in a database each time an identifier tag 772 is detected. The locator 84 may check the time stamps in the database to determine whether an identifier tag 772 has not been determined for a predetermined amount of time, such as 24 hours. If the identifier tag 772 has not been detected within the predetermined amount of time, the locator 84 may generate a query to the shelter node 650 assigned to the displaced person associated with the individual identifier 750 and may send a notification to the administrative computer system 100. The notification may stay active until the identifier tag 772 is detected or scanned, such as by an optical scanner.

Those of skill will appreciate that the various illustrative functional blocks, and algorithm steps described in connection with the embodiments disclosed herein can be implemented as electronic hardware, computer software, or combinations of both. To clearly illustrate this interchangeability of hardware and software, various illustrative components, blocks, and steps have been described above generally in terms of their functionality. Whether such functionality is implemented as hardware or software depends upon the design constraints imposed on the overall system. Skilled persons can implement the described functionality in varying ways for each particular application, but such implementation decisions should not be interpreted as causing a departure from the scope of the invention. In addition, the grouping of functions within a block, or step is for ease of description. Specific functions or steps can be moved from one block without departing from the invention.

The various illustrative functional blocks described in connection with the embodiments disclosed herein can be implemented or performed with a general purpose processor, a digital signal processor (DSP), application specific integrated circuit (ASIC), a field programmable gate array (FPGA) or other programmable logic device, discrete gate or transistor logic, discrete hardware components, or any combination thereof designed to perform the functions described herein. A general-purpose processor can be a microprocessor, but in the alternative, the processor can be any processor, controller, microcontroller, or state machine. A processor can also be implemented as a combination of computing devices, for example, a combination of a DSP and a microprocessor, a plurality of microprocessors, one or more microprocessors in conjunction with a DSP core, or any other such configuration.

The steps of a method or algorithm described in connection with the embodiments disclosed herein can be embodied directly in hardware, in a software module executed by a processor (e.g., of a computer), or in a combination of the two. A software module can reside in RAM memory, flash memory, ROM memory, EPROM memory, EEPROM memory, registers, hard disk, a removable disk, a CD-ROM, or any other form of storage medium. An exemplary storage medium can be coupled to the processor such that the processor can read information from, and write information to, the storage medium. In the alternative, the storage medium can be integral to the processor. The processor and the storage medium can reside in an ASIC.

The above description of the disclosed embodiments is provided to enable any person skilled in the art to make or use the invention. Various modifications to these embodiments will be readily apparent to those skilled in the art, and the generic principles described herein can be applied to other embodiments without departing from the spirit or scope of the invention. Thus, it is to be understood that the description and drawings presented herein represent a presently preferred embodiment of the invention and are therefore representative of the subject matter which is broadly contemplated by the present invention. It is further understood that the scope of the present invention fully encompasses other embodiments that may become obvious to those skilled in the art.

What is claimed is:

1. A humanitarian camp shelter communication system for a humanitarian camp, the humanitarian shelter communication system comprising:
a plurality of shelter nodes, each having
a display,
a wireless receiver, and
a shelter power source for providing electrical power to the shelter node, the shelter power source including a solar panel and a battery connected to the solar panel;
a plurality of individual identifiers, each having an identifying character string and an identifier tag that stores the identifying character string for identifying each of the individual identifiers to the humanitarian camp shelter communication system;
a plurality of tag readers operable to detect the identifier tag and obtain the identifying character string from the identifier tag of each of the individual identifiers;
an administrative computer system having an administrative controller operable to receive displaced person data and associate a displaced person with a shelter node of the plurality of shelter nodes and with an individual identifier of the plurality of individual identifiers;
a communication controller operable to provide communication for the administrative computer system with the plurality of shelter nodes, the communication controller having a locator operable to determine a location of the individual identifier based on which of the plurality of tag readers detected the identifier tag; and
a plurality of routers operable to communicate with the communication controller and to communicate with the plurality of shelter nodes.

2. The humanitarian camp shelter communication system of claim 1, wherein each of the identifier tags includes a radio frequency identification tag and the plurality of tag readers includes a plurality of radio frequency identification readers.

3. The humanitarian camp shelter communication system of claim 2, wherein each of the plurality of individual identifiers includes a second identifier tag including an optical machine readable representation of data, and wherein the administrative computer system includes one of the plurality of tag readers that includes an optical scanner.

4. The humanitarian camp shelter communication system of claim 1, wherein each of the plurality of shelter nodes includes a transmitter and one of the plurality of tag readers.

5. The humanitarian camp shelter communication system of claim 4, wherein each of the plurality of shelter nodes communicate wirelessly other shelter nodes of the plurality of shelter nodes to form a mesh network, and wherein each of the plurality of routers is connected to one of the plurality of shelter nodes.

6. The humanitarian camp shelter communication system of claim 5, wherein the mesh network is a Zigbee network.

7. The humanitarian camp shelter communication system of claim 1, wherein each of the plurality of routers includes one of the plurality of tag readers.

8. The humanitarian camp shelter communication system of claim 1, wherein each of the plurality of shelter nodes includes an emergency button and an emergency requestor that sends an emergency request to the administrative computer system when the emergency button is activated.

9. The humanitarian camp shelter communication system of claim 1, wherein the emergency button is a security button, the emergency requestor is a security requestor, and the emergency request is a request for security at a humanitarian shelter where the shelter node is located, and wherein each of the plurality of shelter nodes further includes a medical button and a medical requestor that sends a request to the administrative computer system when the medical button is activated to request medical aid at the humanitarian shelter where the shelter node is located.

10. A humanitarian camp shelter communication system for a humanitarian camp, the humanitarian shelter communication system comprising:
a plurality of networked shelters having
a shelter node including
a wireless receiver for obtaining messages from an administrative computer system,
a display including an electronic ink display for displaying the messages received from the administrative computer system, and
a shelter power source for providing electrical power to the shelter node, the shelter power source including a solar panel and a battery connected to the solar panel;
a plurality of individual identifiers, each of the individual identifiers having an identifying character string for associating a displaced person with the individual identifier, and an identifier tag that includes a radio frequency identification tag for storing the identifying character string;
a plurality of tag readers, each including a radio frequency identification reader that detects the identifier tag and obtains the identifying character string from the identifier tag of each of the plurality of individual identifiers;
a communication controller for providing communication between the administrative computer system and the plurality of networked shelters, the communication controller having a locator that determines a location of an individual identifier of the plurality of individual identifiers based on which of the plurality of tag readers detected the identifier tag; and
a plurality of routers for communicating with the communication controller and for communicating with the shelter nodes.

11. The humanitarian camp shelter communication system of claim 10, wherein the shelter node for each of the plurality of networked shelters includes one of the plurality of tag readers.

12. The humanitarian camp shelter communication system of claim 10, wherein the shelter node for each of the plurality of networked shelters includes a transmitter to send information to other shelter nodes to form a mesh network, and each of the plurality of routers is connected to one of the shelter nodes.

13. The humanitarian camp shelter communication system of claim 12, wherein the mesh network is a Zigbee network.

14. The humanitarian camp shelter communication system of claim 10, wherein each of the plurality of routers includes one of the plurality of tag readers.

15. The humanitarian camp shelter communication system of claim 10, wherein the shelter node for each of the plurality of networked shelters includes an emergency button and an emergency requestor that sends an emergency request to the administrative computer system when the emergency button is activated.

16. The humanitarian camp shelter communication system of claim 10, wherein each of the individual identifiers includes a second display including a second electronic ink display and a second receiver.

17. The humanitarian camp shelter communication system of claim 15, wherein the display and the emergency button are secured to the humanitarian shelter in a location that is accessible to a displaced person and the other components of the shelter node are secured to the humanitarian shelter in a location out of the reach of the displaced person.

18. A method for managing a humanitarian camp with a humanitarian camp shelter communication system including an administrative computer system, a communication controller, a plurality of routers wirelessly connected to the communication controller, a plurality of shelter nodes wirelessly connected to the communication controller, a plurality of tag readers, and a plurality of individual identifiers, the method comprising:
the administrative computer system associating a displaced person with an individual identifier of the plurality of individual identifiers by linking a character string that identifies the displaced person with an identifying character string of the individual identifier obtained by one of the plurality of tag readers from an identifier tag of the individual identifier;
the communication controller locating the displaced person by determining which of the plurality of tag readers detected the identifier tag;
the administrative computer system associating the displaced person with a shelter node of the plurality of shelter nodes by searching a database for the plurality of shelter nodes for an available shelter node and linking the character string that identifies the displaced person with a second character string that identifies the available shelter node; and
the communication controller sending a message to the displaced person by receiving the message from the administrative computer system, searching the database for the second character string and sending the message the shelter node assigned to the second character string, and the shelter node displaying the message on a display.

19. The method of claim 18, wherein the communication controller locating the displaced person further includes determining whether the displaced person is within a humanitarian shelter, providing the determination to the shelter node, and displaying the determination on the display.

20. The method of claim 18, further comprising the administrative computer system receiving an emergency alert sent by the shelter node when an emergency button is activated and the administrative computer system alerting emergency personnel of the emergency alert.
